(19) United States
(12) Patent Application Publication
(10) Pub. No.: US 2026/0104545 A1
(43) Pub. Date: Apr. 16, 2026

(54) FREE SPACE OPTICAL COMMUNICATIONS OPTICAL PHASED ARRAY REPEATER, DISTRIBUTION NODE AND OPTICAL DATA AGGREGATOR

(71) Applicant: TAARA CONNECT, INC., Sunnyvale, CA (US)

(72) Inventors: Stephen Palese, Menlo Park, CA (US); Devin Brinkley, Redwood City, CA (US); Klaus Ulander, Mountain View, CA (US)

(21) Appl. No.: 19/311,794

(22) Filed: Aug. 27, 2025

Related U.S. Application Data
(60) Provisional application No. 63/707,898, filed on Oct. 16, 2024.

(51) Int. Cl. G02B 6/12; G02B 6/122; H04B 10/11; H04B 10/291

(52) U.S. Cl. CPC G02B 6/12011; G02B 6/12019; G02B 6/122; H04B 10/11; H04B 10/291; G02B 2006/12142; G02B 2006/12161

(57) ABSTRACT

Aspects of the technology provides a method of retransmitting signals. The method may include receiving, by a first optical phased array (OPA) of a device, an optical signal from a remote device; amplifying, by one or more amplifiers of the device, the optical signal in the optical domain; and retransmitting, by a second OPA of the device, the optical signal to one or more remote devices without converting the optical signal from the optical domain.

### CROSS REFERENCE TO RELATED APPLICATIONS

This application claims the benefit of the filing date of United States Provisional Patent Application No. 63/707,898 filed October 16, 2024, the disclosure of which is hereby incorporated herein by reference.

### BACKGROUND

Wireless optical communication enables high-throughput and long-range communication, in part due to high gain offered by the narrow angular width of the transmitted beam. However, the narrow beam also requires that it must be accurately and actively pointed in order to remain aligned to an aperture of a communications terminal at the remote end. This pointing may be accomplished by small mirrors (e.g., microelectromechanical systems or voice-coil based fast-steering mirror mechanisms) that are actuated to steer the beam. In other implementations, electrically controllable steering of beams with no moving parts is used to steer the beam, which provides cost, lifetime and performance advantages. Optical Phased Arrays (OPAs) are a critical technology component, with added benefits of adaptive-optics, point-to-multipoint support, and mesh network topologies. Each active element in the OPA requires electrically controllable phase shifting capability.

### BRIEF SUMMARY

Aspects of the disclosure provide a method of retransmitting signals. The method may include receiving, by a first optical phased array (OPA) of a device, an optical signal from a remote device; amplifying, by one or more amplifiers of the device, the optical signal in the optical domain; and retransmitting, by a second OPA of the device, the optical signal to one or more remote devices without converting the optical signal from the optical domain.

In one example, the optical signal may be a first optical signal; and the method may further include receiving, by the first OPA of the device, a plurality of optical signals. Additionally, the method may further include retransmitting, the second OPA of the device, the plurality of optical signals to the one or more remote devices without converting the plurality of optical signals from the optical domain. Additionally, the retransmitting the plurality of optical signals may include retransmitting the plurality of optical signals as a single signal.

In another example the first OPA and the second OPA may be a single OPA.

In an additional example, the method may further include encoding, by one or more processors of the device, additional information onto the optical signal prior to retransmission.

In another example, the method may further include transmitting, by the first OPA of the device, the optical signal from the first OPA to the second OPA.

In a further example, the optical signal may be transmitted from the first OPA to the second OPA through free space.

In an additional example, the method may further include retransmitting, by the second OPA of the device, a second optical signal to the one or more remote devices. Additionally, the optical signal and the second optical signal may include the same signal information. Additionally or alternatively, the method may further include receiving, by the first OPA of the device, the second optical signal; wherein the optical signal and the second optical signal include different signal information.

In another example, the first OPA and the second OPA may be bidirectional OPAs.

In a further example the amplifying may occur prior to the receiving of the optical signal by the first OPA.

In an additional example, the amplifying may occur after the retransmitting of the optical signal by the second OPA.

In another example, the amplifying may occur after the receiving of the optical signal by the first OPA. Additionally, the amplifying may occur prior to the retransmitting of the optical signal by the second OPA.

In a further example, the optical signal may be received, by the first OPA, from the remote device through one or more optical fibers.

In an additional example, the optical signal may be retransmitted, by the second OPA, to the one or more remote devices through one or more optical fibers.

Another aspect of the disclosure is directed towards a device. The device may include a first optical phased array (OPA) configured to receive optical signals from a first optical fiber bundle and transmit optical signals to a second OPA through free space without converting the optical signals from the optical domain; the second OPA configured to receive optical signals from the first OPA and transmit signals to a second optical fiber bundle without converting the optical signals from the optical domain; a first amplifier array operatively coupled to the first OPA, the first amplifier array configured to amplify signals passing therethrough; and a second amplifier array operatively coupled to the second amplifier array configured to amplify signals passing therethrough.

In one example, the first OPA and the second OPA may be segmented OPAs each including a plurality of segments configured to transmit signals in conjunction or individually.

### BRIEF DESCRIPTION OF THE DRAWINGS

FIG. 1 is a block diagram 100 of a first optical communications terminal and a second optical communications terminal in accordance with aspects of the disclosure.

FIG. 2 is a pictorial diagram 200 of an example system architecture for the first communication terminal of FIG. 1 in accordance with aspects of the disclosure.

FIG. 3 represents features of an OPA architecture represented as an example OPA chip in accordance with aspects of the disclosure.

FIG. 4 is a pictorial diagram of a network in accordance with aspects of the disclosure.

FIG. 5 illustrates an example system in accordance with aspects of the disclosure.

FIG. 6 illustrates an example system in accordance with aspects of the disclosure.

FIG. 7 illustrates an example system in accordance with aspects of the disclosure.

FIG. 8 is a flow diagram in accordance with aspects of the disclosure.

### DETAILED DESCRIPTION

### OVERVIEW

The technology relates to a first device or free space optical (FSO) terminal configured to receive and retransmit signals without conversion from the optical domain using one or more optical phased arrays (OPAs). The first device may be configured as one or more of a repeater, aggregator, and/or distribution node.

Current free space optical (FSO) terminals require conversion of the optical data to an electronic stream and then back to an optical data stream for retransmission. Such conversion leads to increased cost, increased complexity, decreased transmission speed, limited bandwidth, and limited modulation format.

To address this, as noted above, a first device or FSO terminal implementing one or more OPAs may be used to receive and retransmit signals without conversion from the optical domain. The OPAs may allow for desired redirection of signals to remote devices.

### EXAMPLE SYSTEMS

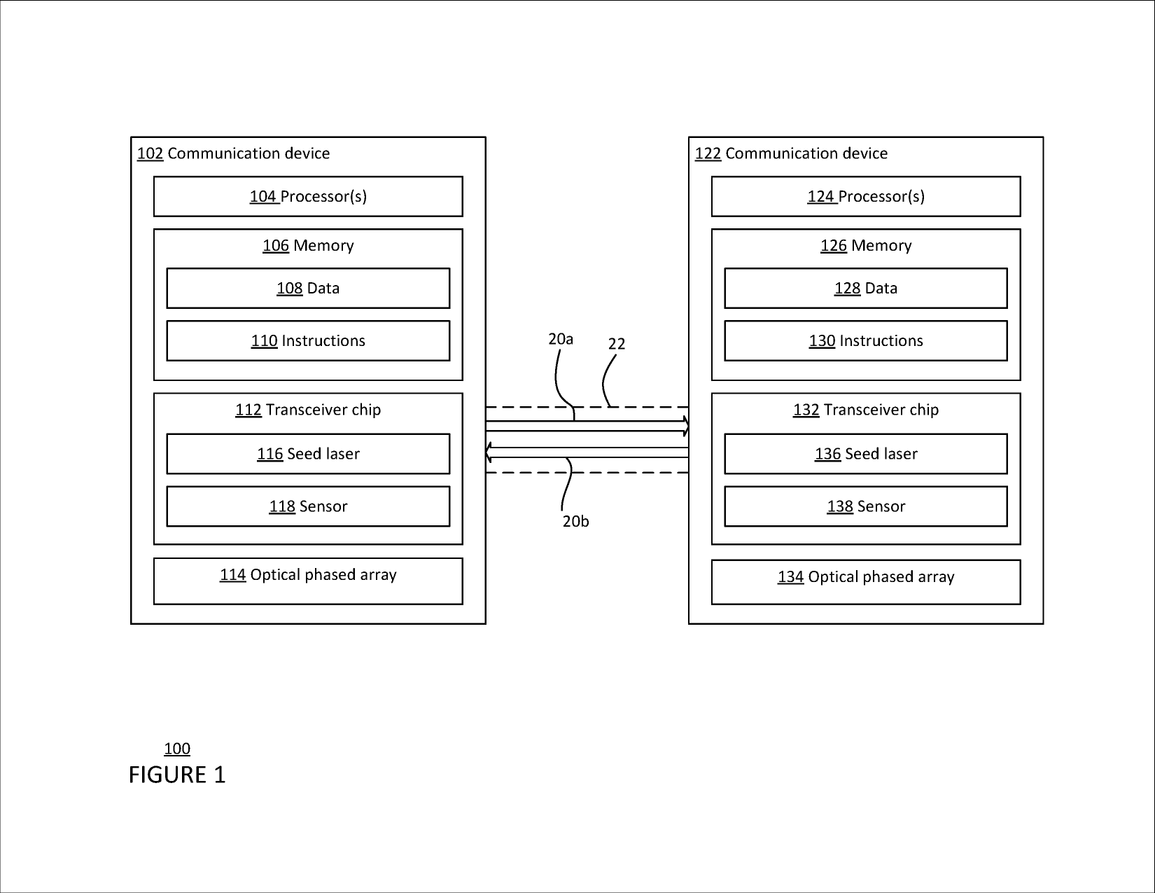

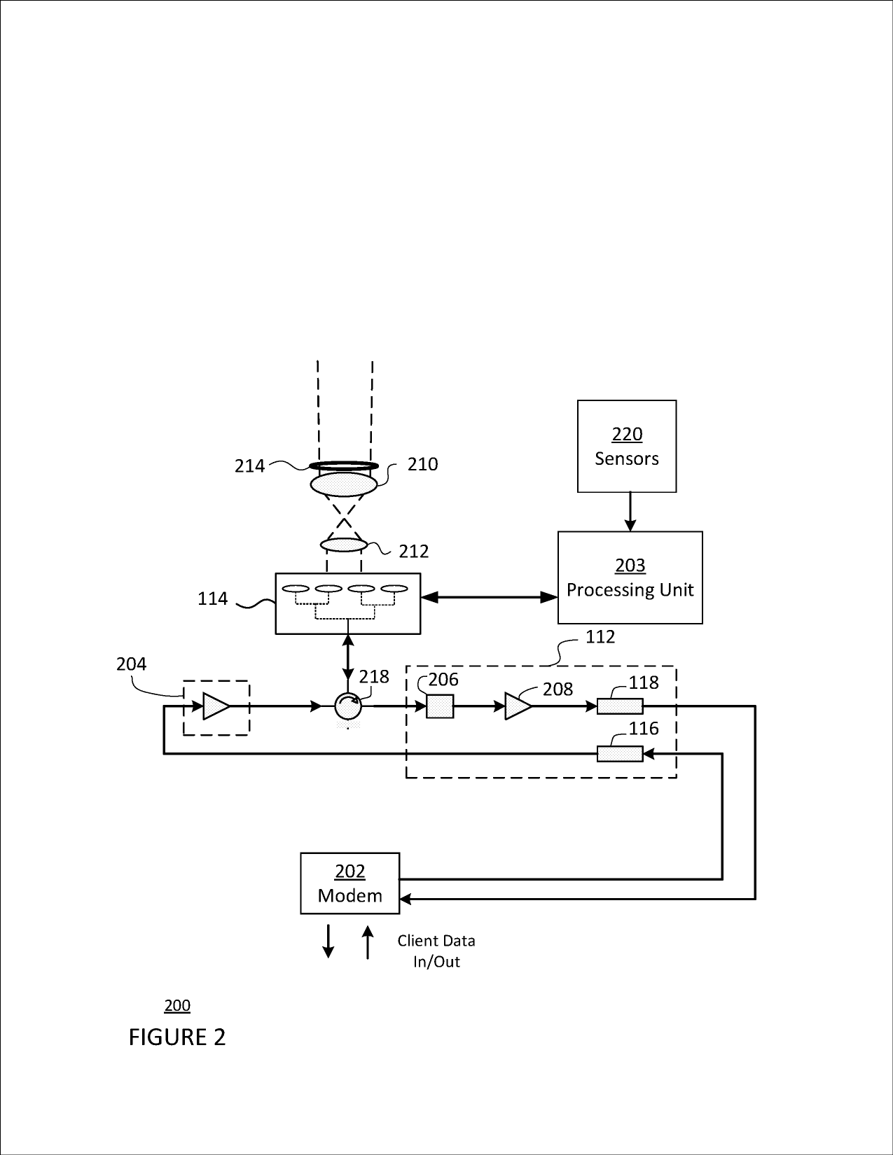

FIG. 1 is a block diagram 100 of a first optical communications terminal configured to form one or more links with a second optical communications terminal, for instance as part of a system such as a free-space optical communication (FSOC) system. FIG. 2 is a pictorial diagram 200 of an example communications terminal, such as the first optical communications terminal of FIG. 1. For example, a first optical communications terminal 102 includes one or more processors 104, a memory 106, a transceiver photonic integrated chip 112, and an optical phased array (OPA) architecture 114. In some implementations, the first optical communications terminal 102 may include more than one transceiver chip and/or more than one OPA architecture (e.g., more than one OPA chip).

The one or more processors 104 may be any conventional processors, such as commercially available CPUs. Alternatively, the one or more processors may be a dedicated device such as an application specific integrated circuit (ASIC) or another hardware-based processor, such as a field programmable gate array (FPGA). Although FIG. 1 functionally illustrates the one or more processors 104 and memory 106 as being within the same block, such as in a modem 202 for digital signal processing shown in FIG. 2, the one or more processors 104 and memory 106 may actually comprise multiple processors and memories that may or may not be stored within the same physical housing, such as in both the modem 202 and a separate processing unit 203. Accordingly, references to a processor or computer will be understood to include references to a collection of processors or computers or memories that may or may not operate in parallel.

Memory 106 may store information accessible by the one or more processors 104, including data 108, and instructions 110, that may be executed by the one or more processors 104. The memory may be of any type capable of storing information accessible by the processor, including a computer-readable medium such as a hard-drive, memory card, ROM, RAM, DVD or other optical disks, as well as other write-capable and read-only memories. The system and method may include different combinations of the foregoing, whereby different portions of the data 108 and instructions 110 are stored on different types of media. In the memory of each communications terminal, such as memory 106, calibration information, such as one or more offsets determined for tracking a signal, may be stored.

Data 108 may be retrieved, stored or modified by one or more processors 104 in accordance with the instructions 110. For instance, although the system and method are not limited by any particular data structure, the data 108 may be stored in computer registers, in a relational database as a table having a plurality of different fields and records, XML documents or flat files. The data 108 may also be formatted in any computer-readable format such as, but not limited to, binary values or Unicode. By further way of example only, image data may be stored as bitmaps including grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data 108 may comprise any information sufficient to identify the relevant information, such as numbers, descriptive text, proprietary codes, references to data stored in other areas of the same memory or different memories (including other network locations) or information that is used by a function to calculate the relevant data.

The instructions 110 may be any set of instructions to be executed directly (such as machine code) or indirectly (such as scripts) by the one or more processors 104. For example, the instructions 110 may be stored as computer code on the computer-readable medium. In that regard, the terms "instructions" and "programs" may be used interchangeably herein. The instructions 110 may be stored in object code format for direct processing by the one or more processors 104, or in any other computer language including scripts or collections of independent source code modules that are interpreted on demand or compiled in advance. Functions, methods and routines of the instructions 110 are explained in more detail below.

The one or more processors 104 may be in communication with the transceiver chip 112. As shown in FIG. 2, the one or more processors in the modem 202 may be in communication with the transceiver chip 112, being configured to receive and process incoming optical signals and to transmit optical signals. The transceiver chip 112 may include one or more transmitter components and one or more receiver components. The one or more processors 104 may therefore be configured to transmit, via the transmitter components, data in a signal, and also may be configured to receive, via the receiver components, communications and data in a signal. The received signal may be processed by the one or more processors 104 to extract the communications and data.

The transmitter components may include at minimum a light source, such as seed laser 116. Other transmitter components may include an amplifier, such as a high-power semiconductor optical amplifier 204. In some implementations, the amplifier is on a separate photonics chip. The seed laser 116 may be a distributed feedback laser (DFB), a laser diode, a fiber laser, or a solid-state laser. The light output of the seed laser 116, or optical signal, may be controlled by a current, or electrical signal, applied directly to the seed laser, such as from a modulator that modulates a received electrical signal. Light transmitted from the seed laser 116 is received by the OPA architecture 114.

The receiver components may include at minimum a sensor 118, such as a photodiode. The sensor may convert a received signal (e.g., light or optical communications beam), into an electrical signal that can be processed by the one or more processors. Other receiver components may include an attenuator, such as a variable optical attenuator 206, an amplifier, such as a semiconductor optical amplifier 208, or a filter.

The one or more processors 104 may be in communication with the OPA architecture 114. The OPA architecture 114 may include a micro-lens array, an emitter associated with each micro-lens in the array, a plurality of phase shifters, and waveguides that connect the components in the OPA. The OPA architecture may be positioned on a single chip, an OPA chip. The waveguides progressively merge between a plurality of emitters and an edge coupler that connect to other transmitter and/or receiver components. In this regard, the waveguides may direct light between photodetectors or fiber outside of the OPA architecture, the phase shifters, the waveguide combiners, the emitters and any additional component within the OPA. In particular, the waveguide configuration may combine two waveguides at each stage, which means the number of waveguides is reduced by a factor of two at every successive stage closer to the edge coupler. The point of combination may be a node, and a combiner may be at each node. The combiner may be a 2x2 multimode interference (MMI) or directional coupler.

The OPA architecture 114 may receive light from the transmitter components and outputs the light as a coherent communications beam to be received by a remote communications terminal or client device, such as second optical communications terminal 122. The OPA architecture 114 may also receive light from free space, such as a communications beam from second optical communications terminal 122, and provides such received light to the receiver components. The OPA architecture may provide the necessary photonic processing to combine an incoming optical communications beam into a single-mode waveguide that directs the beam towards the transceiver chip 112. In some implementations, the OPA architecture may also generate and provide an angle of arrival estimate to the one or more processors 104, such as those in processing unit 203.

The first optical communications terminal 102 may include additional components to support functions of the communications terminal. For example, the first optical communications terminal may include one or more lenses and/or mirrors that form a telescope. The telescope may receive collimated light and output collimated light. The telescope may include an objective portion, an eyepiece portion, and a relay portion. As shown in FIG. 2, the first optical communications terminal may include a telescope including an objective lens 210, an eyepiece lens 212, and an aperture 214 (or opening) through which light may enter and exit the communications terminal. For ease of representation and understanding, the aperture 214 is depicted as distinct from the objective lens 210, though the objective lens 210 may be positioned within the aperture. The first optical communications terminal may include a circulator or wavelength splitter, such as a single mode circulator 218, that routes incoming light and outgoing light while keeping them on at least partially separate paths. The first optical communications terminal may include one or more sensors 220 for detecting measurements of environmental features and/or system components.

The first optical communications terminal 102 may include one or more steering mechanisms, such as one or more bias means for controlling one or more phase shifters, which may be part of the OPA architecture 114, and/or an actuated/steering mirror (not shown), such as a fast/fine pointing mirror. In some examples, the actuated mirror may be a MEMS 2-axis mirror, 2-axis voice coil mirror, or a piezoelectric 2-axis mirror. The one or more processors 104, such as those in the processing unit 203, may be configured to receive and process signals from the one or more sensors 220, the transceiver chip 112, and/or the OPA architecture 114 and to control the one or more steering mechanisms to adjust a pointing direction and/or wavefront shape. The first optical communications terminal also includes optical fibers or waveguides connecting optical components, creating a path between the seed laser 116 and OPA architecture 114 and a path between the OPA architecture 114 and the sensor 118.

Returning to FIG. 1, the second optical communications terminal 122 may output the Tx signals as an optical communications beam 20b (e.g., light) pointed towards the first optical communications terminal 102, which receives the optical communications beam 20b (e.g., light) as corresponding Rx signals. In this regard, the second optical communications terminal 122 includes one or more processors, 124, a memory 126, a transceiver chip 132, and an OPA architecture 134. The one or more processors 124 may be similar to the one or more processors 104 described above.

Memory 126 may store information accessible by the one or more processors 124, including data 128 and instructions 130 that may be executed by processor 124. Memory 126, data 128, and instructions 130 may be configured similarly to memory 106, data 108, and instructions 110 described above. In addition, the transceiver chip 132 and the OPA architecture 134 of the second optical communications terminal 122 may be similar to the transceiver chip 112 and the OPA architecture 114. The transceiver chip 132 may include both transmitter components and receiver components. The transmitter components may include a light source, such as seed laser 136 configured similar to the seed laser 116. Other transmitter components may include an amplifier, such as a high-power semiconductor optical amplifier. The receiver components may include a sensor 138 configured similar to sensor 118. Other receiver components may include an attenuator, such as a variable optical attenuator, an amplifier, such as a semiconductor optical amplifier, or a filter. The OPA architecture 134 may include an OPA chip including a micro-lens array, a plurality of emitters, a plurality of phase shifters. Additional components for supporting functions of the second optical communications terminal 122 may be included similar to the additional components described above. The second optical communications terminal 122 may have a system architecture that is same or similar to the system architecture shown in FIG. 2.

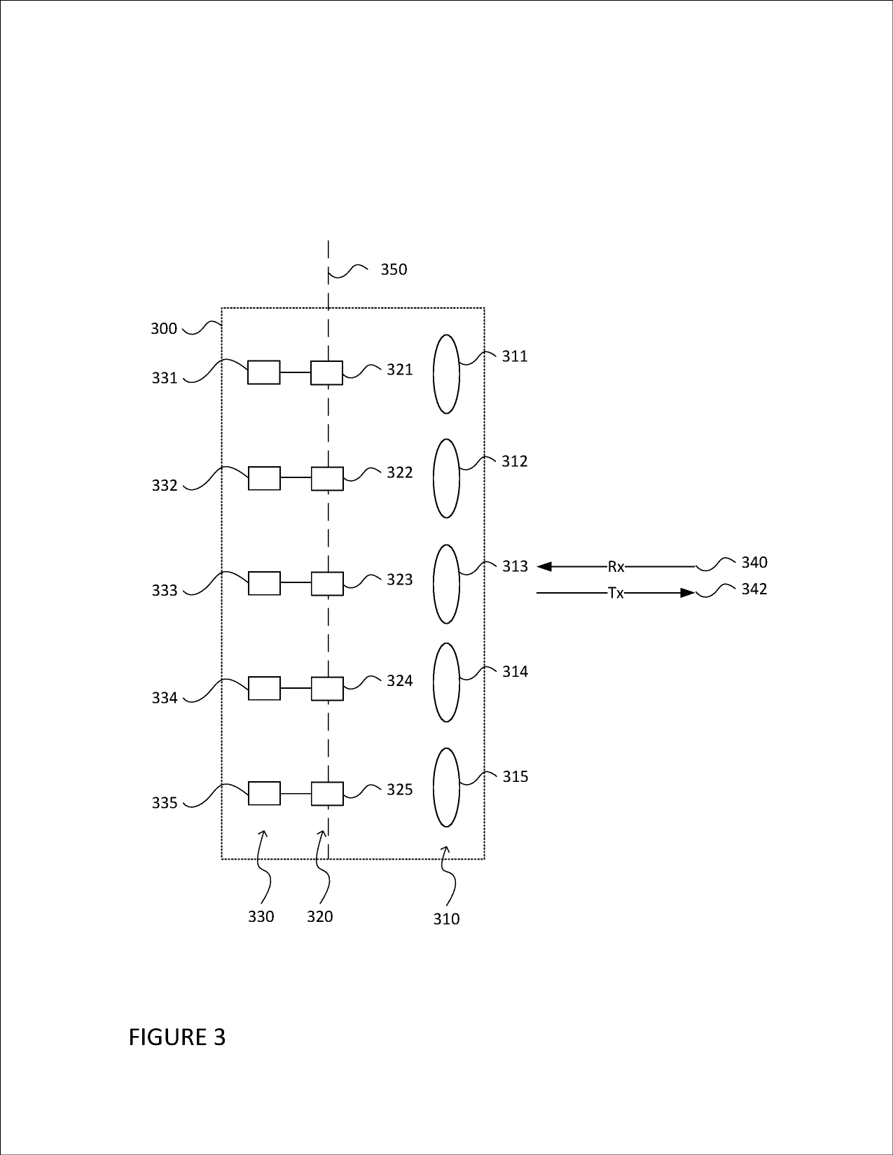

FIG. 3 represent features of OPA architecture 114 represented as an example OPA chip 300 including representations of a micro-lens array 310, a plurality of emitters 320, and a plurality of phase shifters 330. For clarity and ease of understanding, additional waveguides and other features are not depicted. Arrows 340, 342 represent the general direction of Tx signals (transmitted optical communications beam) and Rx signals (received optical communications beam) as such signals pass or travel through the OPA chip 300.

The micro-lens array 310 may include a plurality of convex micro-lenses 311-315 that focus the Rx signals onto respective ones of the plurality emitters positioned at the focal points of the micro-lens array. In this regard, the dashed-line 350 represents the focal plane of the micro-lenses 311-315 of the micro-lens array 310. The micro-lens array 310 may be arranged in a grid pattern with a consistent pitch, or distance, between adjacent lenses. In other examples, the micro-lens array 310 may be in different arrangements having different numbers of rows and columns, different shapes, and/or different pitch (consistent or inconsistent) for different lenses.

Each micro-lens of the micro-lens array may be 10’s to 1000's of micrometers in diameter and height. In addition, each micro-lens of the micro-lens array may be manufactured by molding, printing, or etching a lens directly into a wafer of the OPA chip 300. Alternatively, the micro-lens array 310 may be molded, printed, or etched as a separately fabricated micro-lens array. In this example, the micro-lens array 310 may be a rectangular or square plate of glass or silica a few mm (e.g., 10 mm or more or less) in length and width and 0.2 mm or more or less thick. Integrating the micro-lens array within the OPA chip 300 may allow for the reduction of the grating emitter size and an increase in the space between emitters. In this way, two-dimensional waveguide routing in the OPA architecture may better fit in a single layer optical phased array. In other instances, rather than a physical micro-lens array, the function of the micro-lens array may be replicated using an array of diffractive optical elements (DOE).

Each micro-lens of the micro-lens array may be associated with a respective emitter of the plurality of emitters 320. For example, each micro-lens may have an emitter from which Tx signals are received and to which the Rx signals are focused. As an example, micro-lens 311 is associated with emitter 321. Similarly, each micro-lens 312-315 also has a respective emitter 322-325. In this regard, for a given pitch (i.e., edge length of a micro-lens) the micro-lens focal length may be optimized for best transmit and receive coupling to the underlying emitters. This arrangement may thus increase the effective fill factor of the Rx signals at the respective emitter, while also expanding the Tx signals received at the micro-lenses from the respective emitter before the Tx signals leave the OPA chip 300.

The plurality of emitters 320 may be configured to convert emissions from waveguides to free space and vice versa. The emitters may also generate a specific phase and intensity profile to further increase the effective fill factor of the Rx signals and improve the wavefront of the Tx signals. The phase and intensity profile may be determined using inverse design or other techniques in a manner that accounts for how transmitted signals will change as they propagate to and through the micro-lens array. The phase profile may be different from the flat profile of traditional grating emitters, and the intensity profile may be different from the gaussian intensity profile of traditional grating emitters. However, in some implementations, the emitters may be Gaussian field profile grating emitters.

The phase shifters 330 may allow for sensing and measuring Rx signals and the altering of Tx signals to improve signal strength optimally combining an input wavefront into a single waveguide or fiber. Each emitter may be associated with a phase shifter. As shown in FIG. 3, each emitter may be connected to a respective phase shifter. As an example, the emitter 320 is associated with a phase shifter 330. The Rx signals received at the phase shifters 331-335 may be provided to receiver components including the sensor 118, and the Tx signals from the phase shifters 331-335 may be provided to the respective emitters of the plurality of emitters 320. The architecture for the plurality of phase shifters 330 may include at least one layer of phase shifters having at least one phase shifter connected to an emitter of the plurality of emitters 320. In some examples, the phase shifter architecture may include a plurality of layers of phase shifters, where phase shifters in a first layer may be connected in series with one or more phase shifters in a second layer.

A communication link 22 may be formed between the first optical communications terminal 102 and the second optical communications terminal 122 when the transceivers of the first and second optical communications terminals are aligned. The alignment can be determined using the optical communications beams 20a, 20b to determine when line-of-sight is established between the communications terminals 102, 122. Using the communication link 22, the one or more processors 104 can send communication signals using the optical communications beam 20a to the second optical communications terminal 122 through free space, and the one or more processors 124 can send communication signals using the optical communications beam 20b to the first optical communications terminal 102 through free space. The communication link 22 between the first and second optical communications terminals 102, 122 allows for the bi-directional transmission of data between the two devices. In particular, the communication link 22 in these examples may be free-space optical communications (FSOC) links. In other implementations, one or more of the communication links 22 may be radio-frequency communication links or other type of communication link capable of traveling through free space.

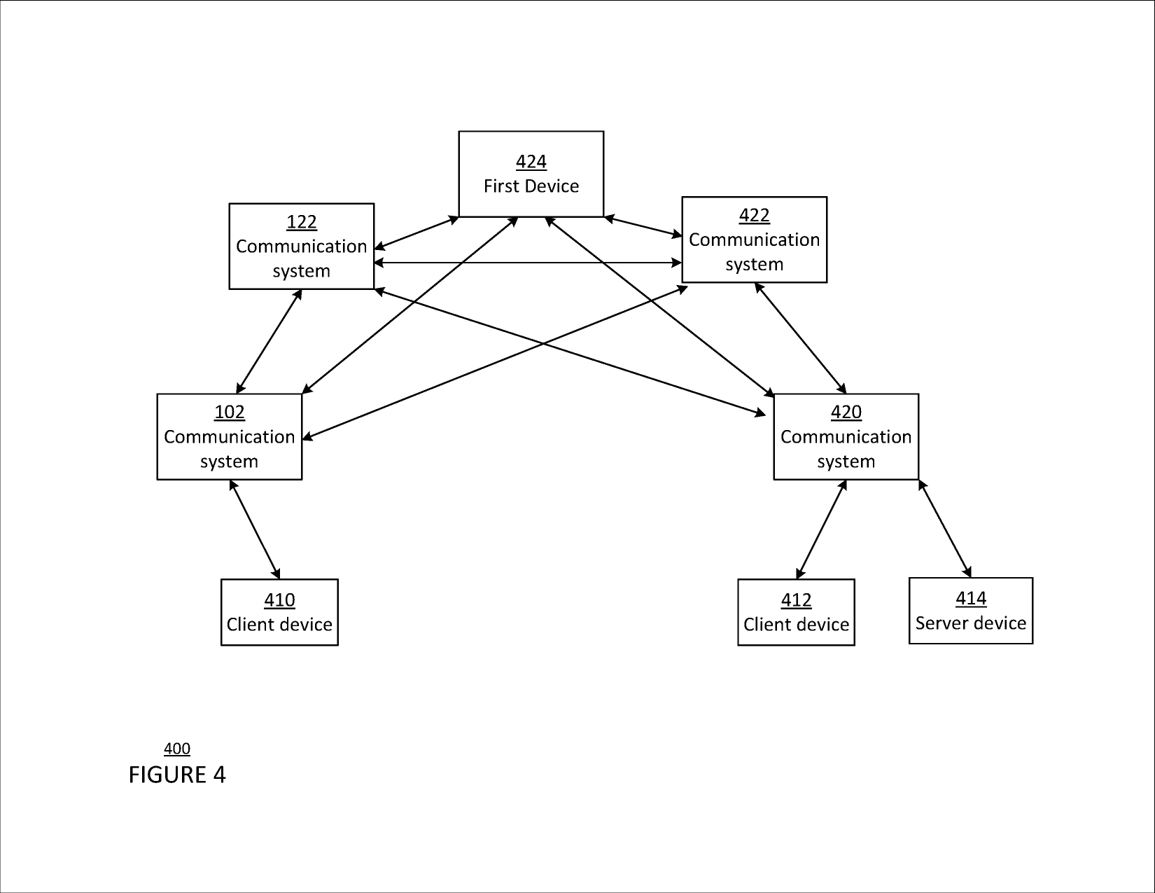

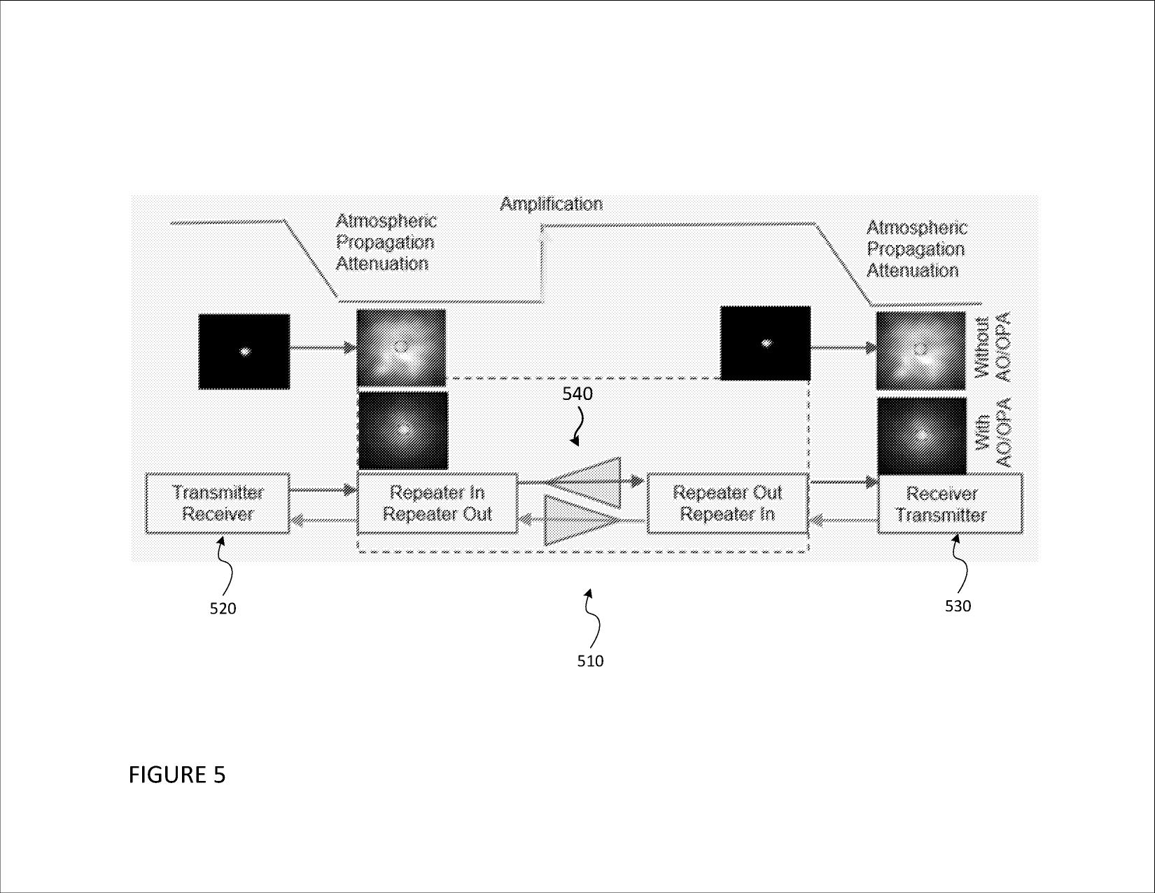

As shown in FIG. 4, a plurality of communications terminals, such as the first optical communications terminal 102 and the second optical communications terminal 122, may be configured to form a plurality of communication links (illustrated as arrows) between a plurality of communications terminals, thereby forming a network 400. The network 400 may include client devices 410 and 412, server device 414, a first device 424, and communications terminals 102, 122, 420, and 422. The first device 424 may be configured as an optical communications terminal, a repeater, a distribution node, and/or an aggregator as discussed below with respect to FIGS. 5-7.

Each of the client devices 410, 412, server device 414, and communications terminals 420 and 422 may include one or more processors, a memory, a transceiver chip, and an OPA architecture (e.g., OPA chip or chips) similar to those described above. Using the transmitter and the receiver, each communications terminal in network 400 may form at least one communication link with another communications terminal, as shown by the arrows. The communication links may be for optical frequencies, radio frequencies, other frequencies, or a combination of different frequency bands. In FIG. 4, the first optical communications terminal 102 is shown having communication links with client device 410 and communications terminals 122, 420, and 422. The second optical communications terminal 122 is shown having communication links with communications terminals 102, 420, and 422.

The network 400 as shown in FIG. 4 is illustrative only, and in some implementations the network 400 may include additional or different communications terminals. The network 400 may be a terrestrial network where the plurality of communications terminals is on a plurality of ground communications terminals. In other implementations, the network 400 may include one or more high-altitude platforms (HAPs), which may be balloons, blimps or other dirigibles, airplanes, unmanned aerial vehicles (UAVs), satellites, or any other form of high-altitude platform, or other types of moveable or stationary communications terminals. In some implementations, the network 400 may serve as an access network for client devices such as cellular phones, laptop computers, desktop computers, wearable devices, or tablet computers. The network 400 also may be connected to a larger network, such as the Internet, and may be configured to provide a client device with access to resources stored on or provided through the larger computer network.

As noted above, signals may be received from one or more remote devices and retransmitted without conversion from the optical domain using a first device. The first device may be an optical communications terminal (e.g., optical communication device). In one instance, the first device may be configured to boost received signals to mitigate the effects of atmospheric propagation attenuation without converting the signals from the optical domain to, for example, the electrical domain. FIG. 5 illustrates an example first device 510 configured as an optical repeater. The first device 510 may be configured to transmit and receive signals from remotes devices 520, 530 by free space or by one or more optical fibers.

The first device 510 may include one or more OPAs configured to transmit and receive signals (e.g., optical communications signals) to and from remote devices 520, 530. Alternatively, the first device 510 may include one or more adaptive optic systems other than an OPA (e.g., deformable mirror, spatial light modulator) that enable compensation of wavefronts of received signals.

As shown in FIG. 5, the first device includes one or more optical amplifiers 540 (e.g., an optical amplifier or an optical amplifier array). The one or more optical amplifiers 540 may be bidirectional. The number of optical amplifiers 540 may be dependent on a power level of signals each of the one or more amplifiers 540 may transmit. The one or more optical amplifiers 540 may be single mode amplifiers, polarization maintaining single mode amplifiers, multimode amplifiers, low order mode amplifiers, polarization maintaining low order mode amplifiers, or polarization maintaining multimode amplifiers. The one or more optical amplifiers 540 can be classical amplifiers or quantum amplifiers. In some instances, multi-mode or low order mode optical amplifiers may be used in systems with moderate data rate systems (<= 25 Gbps). Additionally or alternatively, single mode amplifiers may be used in high data rate systems (>= 100 Gbps). Additionally or alternatively, quantum amplifiers may be utilized in systems where signal to noise levels have a high impact on technical performance metrics (e.g., range, data rate, availability in inclement weather).

The first device 510 may be configured to receive signals from the remote devices 520, 530 as shown and, in some instances, further amplify the signals at the one or more optical amplifiers 540. The amplification may boost the signal such that the effects of atmospheric propagation attenuation are mitigated. The first device 510 may then be configured to retransmit the received signals without conversion from the optical domain to, for example, the electrical domain.

In some examples, the first device 510 may be configured to retransmit signals to a plurality of remote devices 520, 530 without converting the signals from the optical domain to, for example, the electrical domain. In this regard, the first device 510 may receive a signal from a remote device and retransmit the signal to a plurality of remote devices. The plurality of remote devices may be in different directions relative to the first device and/or different distances from the first device. The distances from the first device may be dependent on the optical power level of transmitted signals. The power level of transmitted signals may be due to amplifier technology limitations, eye safety concerns, the receiver sensitivity, and/or the attenuation that occurs at that specific site due to weather conditions.

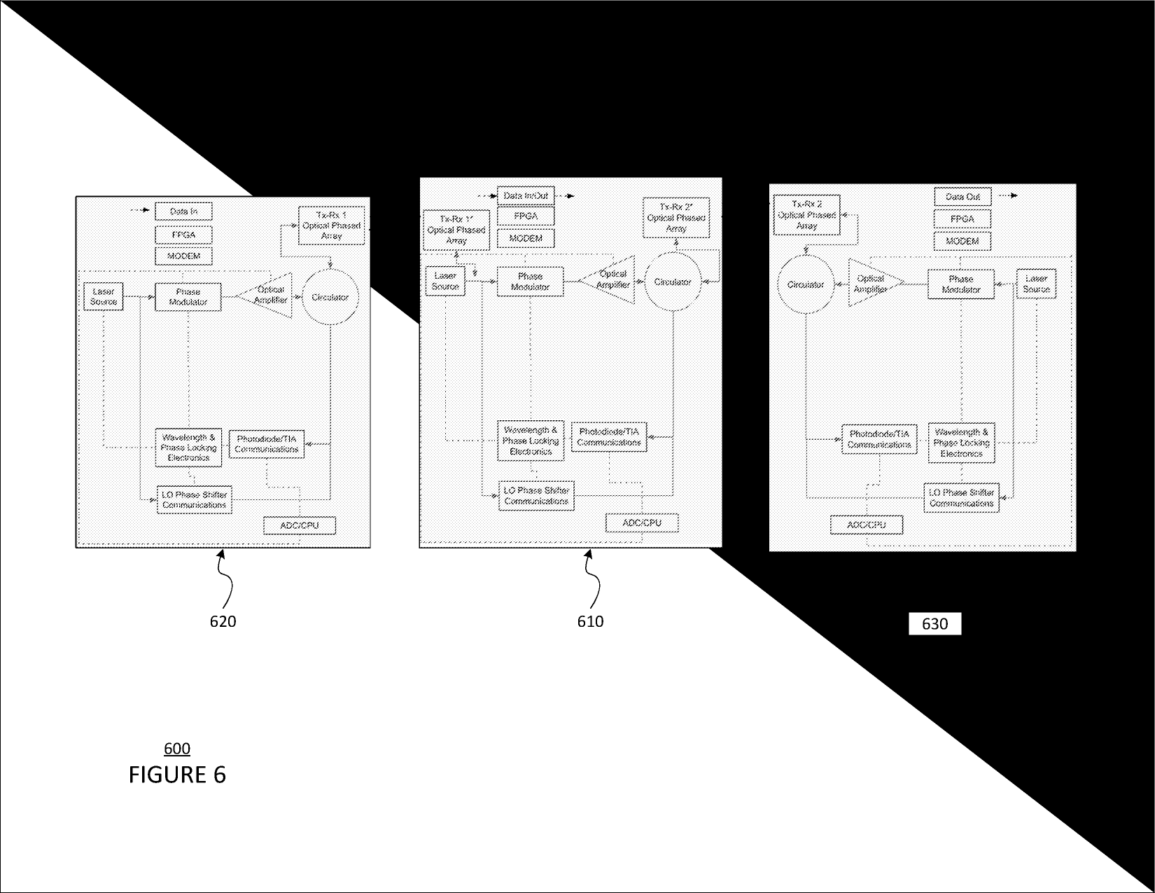

Additionally or alternatively, in another instance, the first device may be configured to boost received signals and/or encode additional information onto the received signals prior to retransmission. In such an instance, the first device may be configured as an aggregator. FIG. 6 illustrates an example system 600 including a first device 610, a first remote device 620, and a second remote device 630. Signals may be transmitted between the devices by free space or by one or more optical fibers.

As illustrated, the first device 610, the first remote device 620 and the second remote device 630 may each include a field programmable gate array (FPGA), a modem, a laser source, a phase modulator, an optical amplifier, a circulator, wavelength and phase locking electronics, a photodiode/transimpedance amplifier (TIA), a linear oscillator (LO) phase shifter, one or more processors, and a bidirectional optical phased array. The components of each device may be connected by one or more waveguides (e.g., optical fibers).

When transmitting an original signal (i.e., a signal originating in the device) by the first device 610, first remote device 620, or second remote device 630, the laser source may generate a signal (e.g., light). The laser source may be a distributed feedback laser (DFB), a laser diode, a fiber laser, a solid-state laser, an extended cavity diode laser (ECL), or a seed laser. The light output of the laser source, or signal, may be controlled by a current, or electrical signal, applied directly to the laser source, such as from a modulator that modulates a received electrical signal.

The generated signal of the first device 610, the first remote device 620, or the second remote device 630 may be directed from the laser source to a phase modulator thereof. The phase modulator may be configured to encode the signal information (e.g., information for an optical communications signal) onto the signal to be transmitted. The signal information may be received at the phase modulator from the FPGA and the modem. In this regard, the FPGA and modem may be configured to drive the phase modulator to encode signal information onto signals passing therethrough.

The generated signal of the first device 610, the first remote device 620, or the second remote device 630 may be directed from the phase modulator to an optical amplifier thereof. The optical amplifier may be configured to increase or boost a power level of (e.g., amplify) a signal. This may, for example, extend range, data rate capabilities and/or area coverage rates of the generated signal. In some instances, when a signal is transmitted, the optical power can be amplified such that the power of the beam remains within eye-safe limits as well as controlled with a feedback loop to avoid saturation effects in an OPA of another device when the signal is received at that other device. In some instances, the optical amplifier may be one or more optical amplifiers and/or be configured in the same or similar manner as the one or more optical amplifiers of the first device.

The generated signal of the first device 610, the first remote device 620, or the second remote device 630 may be directed from the optical amplifier to a circulator or wavelength splitter thereof. The circulator may be configured as a single mode circulator that can route incoming and outgoing signals while keeping those signals on at least partially separate paths. In this regard, the circulator may isolate forward and backward propagating signals such that transmitted signals may be routed to the OPA for transmission and received signals may be routed to the receiver components for receipt. As such, when transmitting a signal, the circulator may connect to and route a signal to the OPA of the device for transmission.

When a signal is received at the first device 610, the first remote device 620, or the second remote device 630 from a different device (e.g., received at the first device 610 from the second remote device 630), the received signal may be routed from the OPA of the device to the circulator of the respective device. As stated above, the circulator may be configured to route incoming and outgoing signals while keeping those signals on at least partially separate paths. In addition, the circulator may isolate forward and backward propagating signals such that transmitted signals may be routed to the OPA for transmission and received signals may be routed to the receiver components for receipt. As an example, the receiver components may include the photodiode/TIA as illustrated in FIG. 6. In some examples, the receiver components may additionally include an attenuator, such as a variable optical attenuator, and/or a filter.

The received signal of the first device 610, the first remote device 620, or the second remote device 630 may be combined or mixed with a signal from the LO phase shifter thereof. The signal from the LO phase shifter may be generated by the laser source. The LO phase shifter may be configured to allow phases of photons and/or wavelengths corresponding to signals (e.g., optical communications signals) to be received at the receiver components. Signals from the LO phase shifter may be mixed with the received signal at the receiver components. The received signal may be amplified by TIA. The photodiode may convert the amplified received signal into the electrical domain. The converted received signal may be digitized by an Analog to Digital Converter (ADC) and further processed by the one or more processors (e.g., FPGA and Central Processing Unit CPU). In some examples, the FPGA may, for example, apply Forward Error Corrections (FEC) algorithms that can reduce Bit Error Rates (BER).

The wavelength and phase locking electronics of the first device 610, the first remote device 620, or the second remote device 630 may be operatively coupled to components of the respective device, such as the laser source, the LO phase shifter, and the receiver components. When a signal is received at the first device 610, the first remote device 620, or the second remote device 630, the wavelength and phase locking electronics may lock the LO phase shifter to one or more specific wavelengths and/or phases corresponding to signals to be received. Such wavelength locking may be used in the receipt of signals since the received signals are from the different sources (e.g., the OPA of a different device). In some examples, the wavelength can be locked to a specific wavelength for coherent homodyne receiver applications or can be slightly offset for coherent heterodyne receiver applications.

The first device 610 may further include an additional OPA. FIG. 6 illustrates the additional OPA as Tx-Rx 1* coupled an outlet waveguide of the laser source. This may allow for signals received from the first remote device 620 to be retransmitted with or without additional information. Additionally, signals received from the first remote device 620 may be retransmitted or relayed without conversion from the optical domain to, for example, the electrical domain. In this regard, the first device 610 may be configured to route signals received from the first remote device 620 to the phase modulator. The one or more processors may be configured to induce the phase modulator to encode additional information onto signals prior to transmission. In this regard, the phase modulator may or may modulate received signals to include additional information prior to transmission. In some examples, the additional information may be received at the phase modulator from the FPGA and the modem. Additionally or alternatively, the additional information may be information received from previous signals. In some instances, the first OPA may be configured as a bidirectional OPA and include the capabilities of both the OPA (e.g., Tx-Rx 2*) and the additional OPA (e.g., Tx-Rx 1*). In one example, received and transmitted signals may have different polarizations such that they do not interfere within the OPA or the device. In such an example, the first device 610 may include a polarizer instead of the circulator.

The signals received from the first remote device 620 may then be routed to the optical amplifier. The optical amplifier may be configured to boost or amplify the signals for retransmission. From the optical amplifier, signals received from the first remote device 620 may be routed to the circulator. The circulator may be configured to route signals received from the first remote device 620 to the OPA of the first device for transmission to the second remote device 630. The OPA of the first device illustrated as Tx-Rx 2* in FIG. 6. In some examples, the first and second remote devices 620630 may include an additional OPA configured in the same manner as the additional OPA of the first device 610.

Additionally or alternatively, in another instance, the first device may be configured to receive and retransmit signals to and from one or more remote devices simultaneously without conversion of the signals from the optical domain to, for example, the electrical domain. In such an instance, the first device may be a distribution node. The first device may be configured to receive a signal (e.g., optical communications signal) and retransmit the signal to a plurality of remote devices, receive a plurality of signals and retransmit the plurality of signals to a remote device as a single signal or as a plurality of signals, and receive a plurality of signals and retransmit the plurality of signals to a plurality of remote devices.

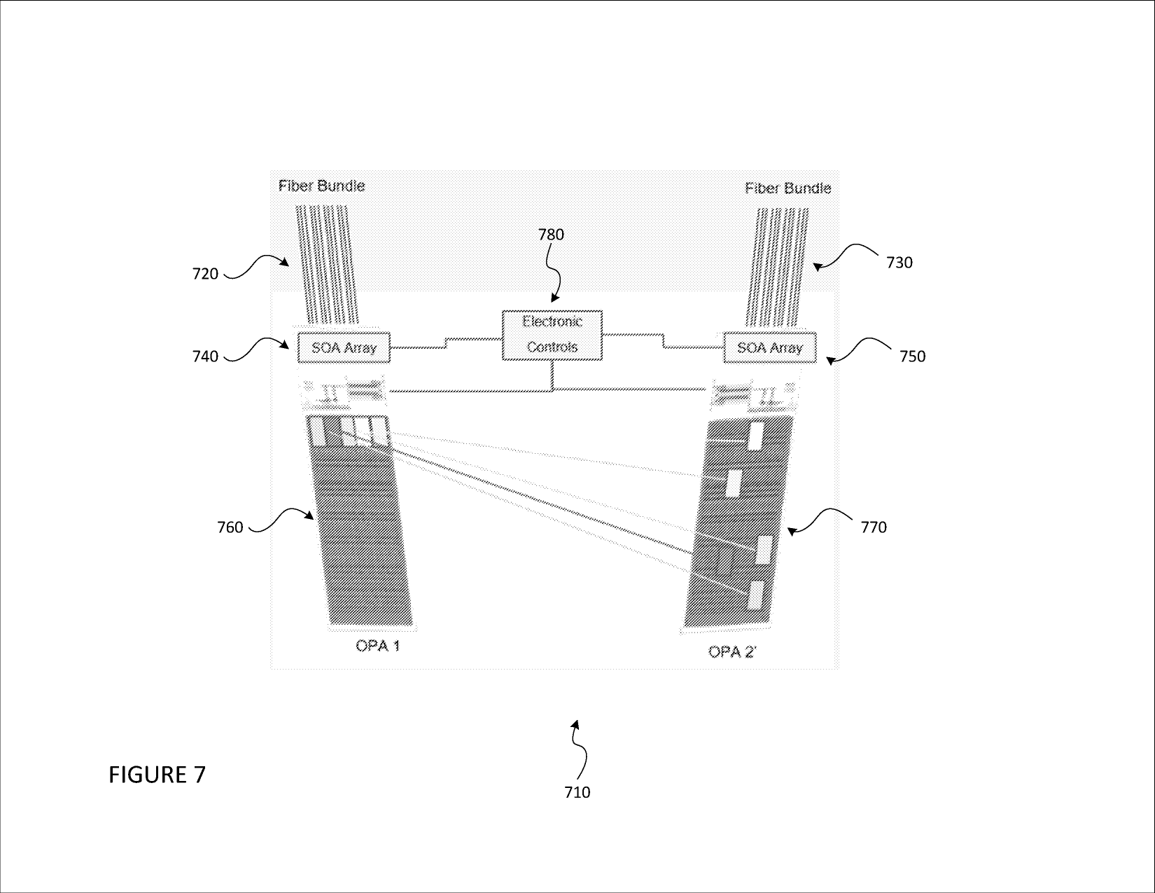

In such an instance, as illustrated in FIG. 7, a first device 710 may include a first fiber bundle 720, a first semiconductor optical amplifier (SOA) array 740, first segmented OPA 760, a second fiber bundle 730, a second SOA array 750, a second segmented OPA 770, and electronic controls 780 including one or more processors.

The first segmented OPA 760 may be configured to transmit and receive signals over free space to and from the second segmented OPA 770 via a plurality of segments. In this regard, the first segmented OPA 760 may include a plurality of segments that may function to transmit and receive signals individually or in conjunction with one or more other segments of the first segmented OPA 760. The functionality of the plurality of segments may be controlled by one or more processors of the electronic controls 780. For example, FIG. 7 illustrates five example segments along the top portion of the first segmented OPA 760. In such an example, each segment may be configured to individually transmit a signal through free space to a segment of the second segmented OPA 770 as illustrated in FIG. 7. The individually transmitted signals may include the same or different signal information. In this regard, the transmitted signals may each include unique signal information or two or more of the signals may include identical signal information. Similarly, each segment may be configured to individually receive a signal through free space from a segment of the second segmented OPA 770 as illustrated in FIG. 7.

Alternatively, two or more of the five segments may be configured to transmit a signal in conjunction with one another through free space to a segment of the second segmented OPA 770. Similarly, two or more of the five segments may be configured to receive a signal in conjunction with one another through free space to a segment of the second segmented OPA 770.

While only five segments are illustrated in the first segmented OPA 760, the first segmented OPA 760 may include any number of segments which may function individually or with any number of other segments of the first segmented OPA 760. When transmitting signals, the first segmented OPA 760 may encode each signal with a differing wavelength such that the signals do not interfere when being transmitted to the second segmented OPA 770. The second segmented OPA 770 may be configured in the same or similar manner as the first segmented OPA 760.

The first SOA array 740 may be configured to amplify signals passing therethrough before or after retransmission. The first fiber 720 bundle may be an optical fiber bundle. The first fiber bundle 720 may be configured to route signals to and from the first segmented OPA 760 and a plurality of remote devices through the first SOA array 740. One or more fibers of the first fiber bundle 720 may be configured to receive signals from one or more of the plurality of segments of the first segmented OPA 760. The one or more processors of the electronic controls 780 may be configured to control the first segmented OPA 760 and segments thereof to direct signals to the fibers of the first fiber bundle. Additionally the one or more processors of the electronic controls 780 may be configured to control the first segmented OPA 760 to transmit signals received from one or more fibers of the first fiber bundle 720 using one or more segments of the first segmented OPA 760.

For example, a fiber of the first fiber bundle 720 may receive a signal from one segment of the first segmented OPA 760 functioning individually or multiple segments of the first segmented OPA 760 functioning in conjunction. In another example, multiple fibers of the first fiber bundle 720 may receive a signal from one segment of the first segmented OPA 760 functioning individually or multiple segments of the first segmented OPA 760 functioning in conjunction.

Similarly, the second SOA array 750 may be configured to amplify signals passing therethrough before or after retransmission. The second fiber bundle 730 may be an optical fiber bundle. The second fiber bundle 730 may be configured to route signals to and from the second segmented OPA 770 and a plurality of remote devices through the second SOA array 750. One or more fibers of the second fiber bundle 730 may be configured to receive signals from one or more of the plurality of segments of the second segmented OPA 770. The one or more processors of the electronic controls 780 may be configured to control the second segmented OPA 770 and segments thereof to direct signals to the fibers of the second fiber bundle 730. Additionally the one or more processors of the electronic controls 780 may be configured to control the second segmented OPA 770 to transmit signals received from one or more fibers of the second fiber bundle 730 using one or more segments of the second segmented OPA 770.

While illustrated as coupled to fiber bundles, in some instances, the first and second segmented OPAs 760, 770 may be configured to transmit and receive signal via free space to and from remote devices. Additionally or alternatively, while illustrated between respective fiber bundles 720, 730 and segmented OPAs 760, 770 the SOA arrays 740, 750 can be distributed anywhere along the transmitter/receiver path.

### EXAMPLE METHODS

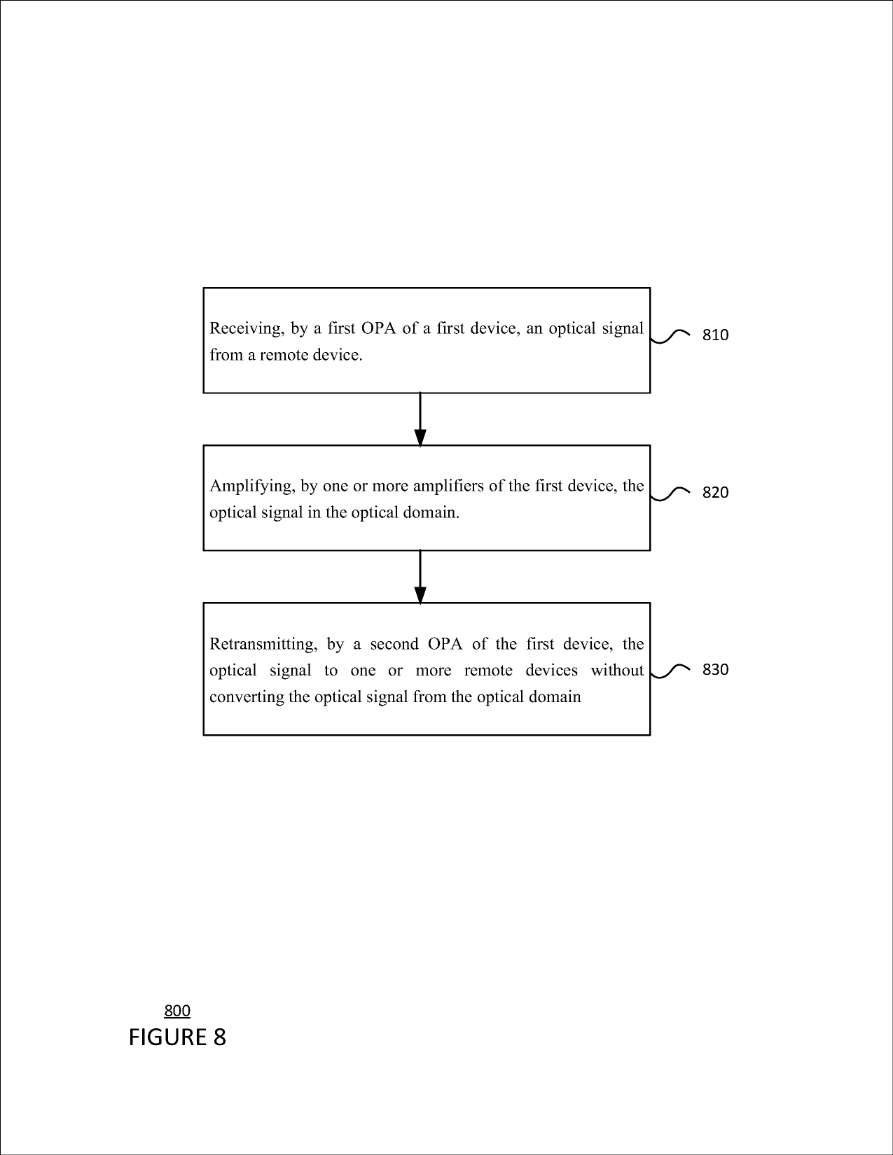

As discussed above, signals may be received from one or more remote devices and retransmitted without conversion from the optical domain using a first device. In this regard, the first device may be used in a method of retransmitting signals, FIG. 8 illustrates an example method 800 of retransmitting signals. At block 810, the method includes receiving, by a first OPA of a first device, an optical signal from a remote device. In this regard, an OPA of the first device 424, 510, 610, 710 may receive an optical signal (e.g., optical communications beam) from a remote device 102, 122, 520, 530, 620, 630 as discussed above with respect to, for example, FIGS. 1, 5, 6, and 7. In some instances, this may include receiving a plurality of optical signals from a plurality of remote devices 102122, 520, 530, 620, 630. The plurality of optical signals may or may not include the same signal information.

At block 820 the method further includes amplifying, by one or more amplifiers of the first device the optical signal in the optical domain. In this regard, one or more amplifiers 540, 740, 750 of the first device 424, 510, 610, 710 may amplify the optical signal after receiving the signal at an OPA 300, 760, 770 of the first device as discussed above with respect to, for example, FIGS. 1, 5, 6, and 7. Additionally or alternatively, one or more amplifiers 740, 750 of the first device 710 may amplify the optical signal prior to receiving the signal at an OPA 300, 760, 770 of the first device 710 as discussed above with respect to, for example, FIG. 7. The amplification may occur in the optical domain without converting the signal therefrom to, for example, the electrical domain.

At block 830, the method further includes, retransmitting, by a second OPA of the first device, the optical signal to one or more remote devices without converting the optical signal from the optical domain. In this regard, an OPA 300, 760, 770 of the first device 510, 610, 710 may transmit the optical signal to a remote device 520, 530, 620, 630 as discussed above with respect to, for example, FIGS. 5, 6, and 7. In some instances, this may include transmitting a plurality of optical signals to a plurality of remote devices. The plurality of optical signals may or may not include the same signal information.

In some instances, the method may further include receiving an optical signal using one or more receiver components as discussed with respect to, for example, FIG. 6. Additionally or alternatively, in some instances, the method may further include encoding additional information onto the optical beam as discussed with respect to, for example, FIG. 6.

The features and methodology described herein may provide a first device able to receive and retransmit signals without conversion from the optical domain. Such capabilities allow for retransmission and redirection of signals at a decreased cost, decreased complexity, increased transmission speed, increased bandwidth, and increased modulation format without loss in signal quality. In this regard, the device described herein can amplify all of the wavelengths of a received signal and is flexible in that it can accommodate all modulation formats. Such capabilities allow for increased upgrade capacity and the ability to work with current generation moderate bandwidth (<=25 Gbps) direct detect systems as well as next generation coherent architectures (>=100 Gbps).

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as "such as," "including" and the like, should not be interpreted as limiting the subject matter of the claims to the specific examples; rather, the examples are intended to illustrate only one of many possible embodiments. Further, the same reference numbers in different drawings can identify the same or similar elements.

1. A method of retransmitting signals, the method comprising:
receiving, by a first optical phased array (OPA) of a device, an optical signal from a remote device;
amplifying, by one or more amplifiers of the device, the optical signal in the optical domain; and
retransmitting, by a second OPA of the device, the optical signal to one or more remote devices without converting the optical signal from the optical domain.

2. The method of claim 1, wherein:
the optical signal is a first optical signal; and
the method further includes receiving, by the first OPA of the device, a plurality of optical signals.

3. The method of claim 2, further comprising retransmitting, the second OPA of the device, the plurality of optical signals to the one or more remote devices without converting the plurality of optical signals from the optical domain.

4. The method of claim 3, wherein the retransmitting the plurality of optical signals includes retransmitting the plurality of optical signals as a single signal.

5. The method of claim 1, wherein the first OPA and the second OPA are a single OPA.

6. The method of claim 1, further comprising encoding, by one or more processors of the device, additional information onto the optical signal prior to retransmission.

7. The method of claim 1, further comprising transmitting, by the first OPA of the device, the optical signal from the first OPA to the second OPA.

8. The method of claim 7, wherein the optical signal is transmitted from the first OPA to the second OPA through free space.

9. The method of claim 1, further comprising retransmitting, by the second OPA of the device, a second optical signal to the one or more remote devices.

10. The method of claim 9, wherein the optical signal and the second optical signal include the same signal information.

11. The method of claim 9, further comprising:
receiving, by the first OPA of the device, the second optical signal;
wherein the optical signal and the second optical signal include different signal information.

12. The method of claim 1, wherein the first OPA and the second OPA are bidirectional OPAs.

13. The method of claim 1, wherein the amplifying occurs prior to the receiving of the optical signal by the first OPA.

14. The method of claim 1, wherein the amplifying occurs after the retransmitting of the optical signal by the second OPA.

15. The method of claim 1, wherein the amplifying occurs after the receiving of the optical signal by the first OPA.

16. The method of claim 15, wherein the amplifying occurs prior to the retransmitting of the optical signal by the second OPA.

17. The method of claim 1, wherein the optical signal is received, by the first OPA, from the remote device through one or more optical fibers.

18. The method of claim 1, wherein the optical signal is retransmitted, by the second OPA, to the one or more remote devices through one or more optical fibers.

19. A device comprising:
a first optical phased array (OPA) configured to receive optical signals from a first optical fiber bundle and transmit optical signals to a second OPA through free space without converting the optical signals from the optical domain;
the second OPA configured to receive optical signals from the first OPA and transmit signals to a second optical fiber bundle without converting the optical signals from the optical domain;
a first amplifier array operatively coupled to the first OPA, the first amplifier array configured to amplify signals passing therethrough; and
a second amplifier array operatively coupled to the second amplifier array configured to amplify signals passing therethrough.

20. The device of claim 19, wherein the first OPA and the second OPA are segmented OPAs each including a plurality of segments configured to transmit signals in conjunction or individually.
